(19) United States
(12) Patent Application Publication
(10) Pub. No.: US 2026/0227819 A1
(43) Pub. Date: Aug. 6, 2026

(54) OPERATION SYSTEM

(71) Applicant: TOYOTA JIDOSHA KABUSHIKI KAISHA, Toyota-shi (JP)

(72) Inventors: Emi SAKAOKA, Numazu-shi (JP); Yuki Suehiro, Susono-shi (JP); Rio Suda, Toyota-shi (JP)

(73) Assignee: TOYOTA JIDOSHA KABUSHIKI KAISHA, Toyota-shi (JP)

(21) Appl. No.: 19/428,648

(22) Filed: Dec. 22, 2025

(30) Foreign Application Priority Data
Feb. 6, 2025 (JP) 2025-018396

(51) Int. Cl. G05G 9/047

(52) U.S. Cl. CPC G05G 9/047; G05G 2009/0474

(57) ABSTRACT

An operation system operates a target in response to an operation of an operation member by an operator. The operation system includes one or more processors and one or more storage devices. The one or more processors are configured to receive an operation input value representing an operation content of the operation member by the operator. The one or more storage devices are configured to store information on a model configured to output an operation output value corresponding to the operation input value. The model is configured to exhibit a hysteresis characteristic in a relationship between the operation input value and the operation output value. The one or more processors are further configured to acquire the operation output value by inputting the operation input value to the model, and determine an operation amount of the target based on the operation output value.

### CROSS-REFERENCE TO RELATED APPLICATION

This application claims priority to Japanese Patent Application No. 2025-018396 filed on Feb. 6, 2025. The disclosure of the above-identified application, including the specification, drawings, and claims, is incorporated by reference herein in its entirety.

### BACKGROUND

### 1. Technical Field

The present disclosure relates to a technique for operating a target in response to an operation of an operation member by an operator.

### 2. Description of Related Art

Japanese Unexamined Patent Application Publication No. 2017-085751 (JP 2017-085751 A) discloses a joystick signal processing device for a vehicle. An operator of the vehicle operates a joystick to operate the vehicle. The joystick signal processing device outputs an operation output value corresponding to an operation input value representing an operation amount of the joystick by the operator. The operation input value and the operation output value are in a one-to-one correspondence.

### SUMMARY

According to the technique described in JP 2017-085751 A, the operation input value and the operation output value by the operator are in a one-to-one correspondence. Therefore, the operation output value may fluctuate due to hand tremor of the operator, and the operation output value may be difficult to be kept constant.

One object of the present disclosure is to provide a technique capable of improving operability when an operator operates an operation member to operate a target.

One viewpoint of the present disclosure relates to an operation system that operates a target in response to an operation of an operation member by an operator.

The operation system includes one or more processors and one or more storage devices.
The one or more processors are configured to receive an operation input value representing an operation content of the operation member by the operator.
The one or more storage devices are configured to store information on a model configured to output an operation output value corresponding to the operation input value. The model is configured such that a relationship between the operation input value and the operation output value has a hysteresis characteristic.
The one or more processors are further configured to input the operation input value to the model to acquire the operation output value, and determine an operation amount of the target based on the operation output value.

According to the present disclosure, the model outputs the operation output value corresponding to the operation input value representing the operation content of the operation member by the operator. The model is configured such that the relationship between the operation input value and the operation output value has the hysteresis characteristic. The operation amount of the target is determined based on the operation output value from the model. Therefore, it is possible to keep the operation amount of the target even in a case where the operation input value fluctuates. As a result, the operability for the operator is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an outline of an operation system;

FIG. 2 is a conceptual diagram for describing a first example of an operation amount determination unit of the operation system;

FIG. 3 is a conceptual diagram for describing an example of processing by the conversion unit;

FIG. 4 is a conceptual diagram for describing a second example of the operation amount determination unit of the operation system;

FIG. 5 is a conceptual diagram for describing a third example of the operation amount determination unit of the operation system; and

FIG. 6 is a block diagram showing a hardware configuration example of the operation system.

### DETAILED DESCRIPTION OF EMBODIMENTS

Embodiments of the present disclosure will be described with reference to the accompanying drawings.

### 1. Outline of Operation System

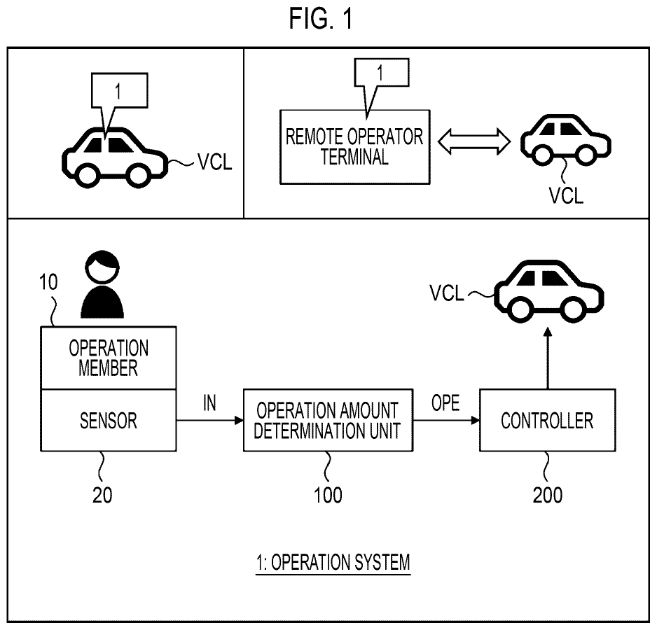

FIG. 1 is a conceptual diagram for describing an outline of an operation system 1 according to the present embodiment. The operation system 1 is a system for the operator to operate the target. The target is, for example, a mobile body. Examples of the mobile body include a vehicle, a robot, a construction machine, a flying body, and a ship.

The operation system 1 includes an operation member 10 operated by the operator to operate the target. The operation member 10 can be operated (used) by at least one of the hands and feet of the operator. For example, the operation member 10 includes a movable member that can be physically moved by the operator. Examples of the movable member include a steering wheel, an accelerator pedal, a brake pedal, a joystick, and a lever.

For example, the operation member 10 includes one or more joysticks. The operation member 10 may include a steering joystick and an acceleration and deceleration joystick. For example, pulling the steering joystick is associated with “left turning”, and pressing the steering joystick is associated with “right turning”, respectively. In addition, pulling the acceleration and deceleration joystick is associated with “deceleration”, and pressing the acceleration and deceleration joystick is associated with “acceleration”, respectively.

FIG. 1 shows, as an example, a case where the target is a vehicle VCL. For example, the operator is a driver who is on board the vehicle VCL and drives the vehicle VCL. The operation member 10 is mounted on the vehicle VCL. The driver operates the operation member 10 to drive the vehicle VCL.

As another example, the operator may be a remote operator who remotely operates (remotely drives) the vehicle VCL. In this case, the operation member 10 is provided in the remote operator terminal. The remote operator terminal and the vehicle VCL can communicate with each other. The remote operator operates the operation member 10 provided in the remote operator terminal. Remote operation information representing the operation content of the operation member 10 is transmitted from the remote operator terminal to the vehicle VCL. The vehicle VCL is controlled in accordance with the remote operation information. As described above, the remote operator can remotely operate the vehicle VCL by operating the operation member 10.

As shown in FIG. 1, the operation system 1 includes a sensor 20, an operation amount determination unit 100, and a controller 200 in addition to the operation member 10.

The sensor 20 detects the operation content of the operation member 10 by the operator. Examples of the operation content include an operation amount, an operation speed, and an operation force. For example, the sensor 20 includes a force sensor that detects a force applied to the operation member 10. Here, the force is a concept including torque. The operation input value IN represents a detection result by the sensor 20, that is, the operation content of the operation member 10 by the operator. For example, the operation input value IN represents the force applied to the operation member 10.

The operation amount determination unit 100 receives the operation input value IN from the sensor 20. The operation amount determination unit 100 determines the operation amount OPE of the target according to the received operation input value IN. That is, the operation amount determination unit 100 determines the operation amount OPE corresponding to the operation input value IN by the operator and outputs the operation amount OPE.

The controller 200 receives the operation amount OPE determined by the operation amount determination unit 100. The controller 200 operates (controls) the target in accordance with the operation amount OPE. In a case of the remote operation system, the controller 200 is included in the target of the remote operation.

Hereinafter, the operation amount determination unit 100 of the operation system 1 according to the present embodiment will be described in more detail.

### 2. Example of Operation Amount Determination Unit

### 2-1. First Example

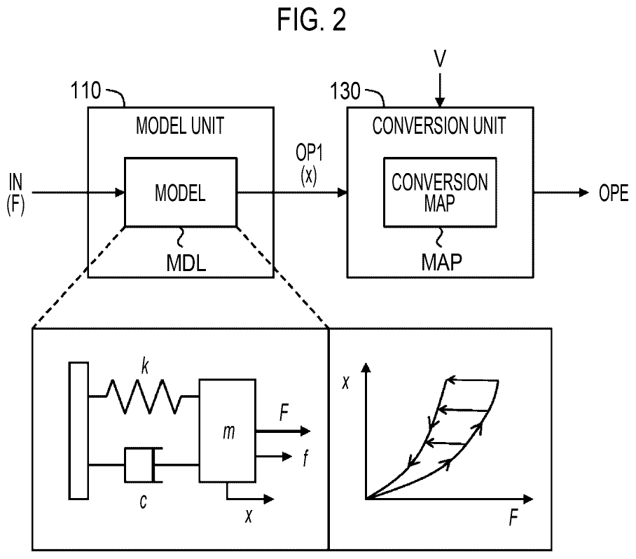

FIG. 2 is a conceptual diagram for describing a first example of the operation amount determination unit 100. The operation amount determination unit 100 includes a model unit 110 and a conversion unit 130.

The model unit 110 receives the operation input value IN and outputs the operation output value OP1 corresponding to the received operation input value IN. More specifically, the model unit 110 includes a model MDL configured to output the operation output value OP1 corresponding to the operation input value IN. The model unit 110 acquires the operation output value OP1 corresponding to the operation input value IN by inputting the operation input value IN to the model MDL. According to the present embodiment, the model MDL is configured to exhibit a hysteresis characteristic in a relationship between the operation input value IN and the operation output value OP1.

For example, the model MDL is a “spring-mass-damper model” as shown in FIG. 2. The spring-mass-damper model includes a spring, a mass (m), and a damper, and configured by a combination thereof. k is a spring constant of the spring. c is a damping coefficient of the damper. x is a displacement of the mass. The operation input value IN represents the force applied to the operation member 10. The force applied to the operation member 10 is hereinafter referred to as an “operation input F”. The operation input F is applied to the mass (m) of the spring-mass-damper model. At this time, a differential equation (motion equation) represented by the following Equation (1) is established.

$$m \ddot{x} + c \dot{x} + kx + f = F \qquad ( 1 )$$

In addition, the natural frequency ω and the damping ratio ξ are represented by the following Equations (2) and (3), respectively.

$$ω = \sqrt{\frac{k}{m}} \qquad ( 2 )$$

In the case of the spring-mass-damper model, the mass displacement x is used as the operation output value OP1. That is, the spring-mass-damper model outputs the mass displacement x corresponding to the operation input F by the operator as the operation output value OP1. The relationship between the operation input F and the mass displacement x has a hysteresis characteristic. It is possible to realize the hysteresis characteristic by using the spring-mass-damper model.

The conversion unit 130 receives the operation output value OP1 output from the model unit 110. The conversion unit 130 converts the operation output value OP1 into the operation amount OPE of the target. That is, the conversion unit 130 determines (calculates) the operation amount OPE of the target based on the operation output value OP1. The conversion unit 130 may include a conversion map MAP for converting the operation output value OP1 into the operation amount OPE.

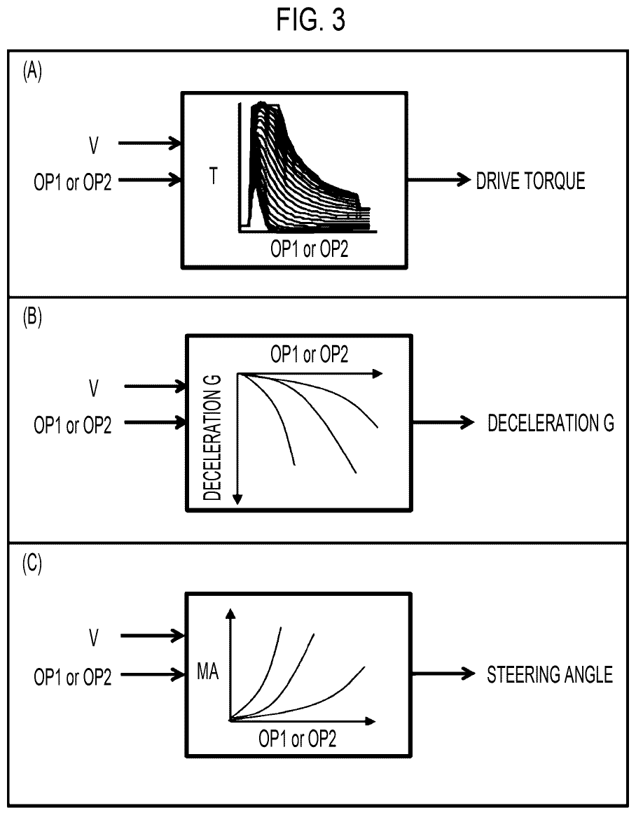

FIG. 3 is a conceptual diagram for describing an example of processing by the conversion unit 130. In the present example, the target is the vehicle VCL. Examples of the operation amount OPE of the vehicle VCL include a drive torque T, acceleration, and a steering angle MA. The operation amount OPE may be determined based on the operation output value OP1 and the speed V of the vehicle VCL. The controller 200 (see FIG. 1) controls the vehicle VCL in accordance with the operation amount OPE determined in this way.

As described above, according to the present embodiment, the model MDL outputs the operation output value OP1 corresponding to the operation input value IN representing the operation content of the operation member 10 by the operator. The model MDL is configured to exhibit a hysteresis characteristic in a relationship between the operation input value IN and the operation output value OP1. The operation amount OPE of the target is determined based on the operation output value OP1 from the model MDL. Therefore, it is possible to keep the operation amount OPE of the target even in a case where the operation input value IN fluctuates. As a result, the operability for the operator is improved.

### 2-2. Second Example

In the second example, the hysteresis characteristic of the model MDL is variable. It is possible to change (adjust) the hysteresis characteristic by changing (adjusting) the tuning parameter included in the model MDL. For example, in the case of the spring-mass-damper model, the tuning parameter includes (m, k, c, f) or (m, ¿, @, f).

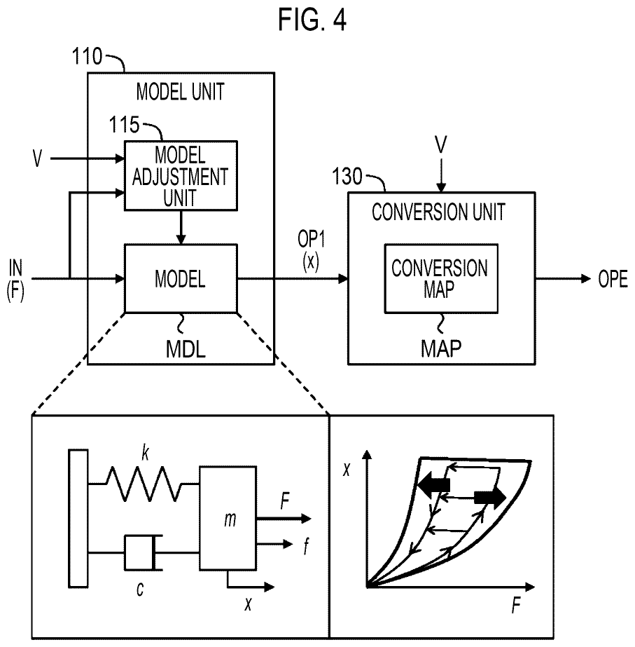

FIG. 4 is a conceptual diagram for describing a second example of the operation amount determination unit 100. The description overlapping the first example is appropriately omitted. The model unit 110 includes a model adjustment unit 115. The model adjustment unit 115 adjusts the hysteresis characteristic of the model MDL by adjusting the tuning parameter of the model MDL.

For example, the model adjustment unit 115 acquires information on the operation speed of the operation member 10 based on the operation input value IN. The model adjustment unit 115 dynamically changes (adjusts) the hysteresis characteristic by dynamically changing (adjusting) the tuning parameter according to the operation speed. For example, in a case where the operation speed is low, the damping ratio ¿ is set to be large such that the change in the operation output value OP1 is suppressed. On the other hand, in a case where the operation speed is high, the damping ratio (is set to be small such that the operation output value OP1 is easily changed.

As another example, the model adjustment unit 115 may dynamically change (adjust) the hysteresis characteristic by dynamically changing (adjusting) the tuning parameter according to the speed V of the vehicle VCL. For example, in a case where the speed V is high, the damping ratio (is set to be large such that the change in the operation output value OP1 is suppressed. On the other hand, in a case where the speed V is low, the damping ratio ξ is set to be small such that the operation output value OP1 is easily changed.

As described above, according to the second example, the hysteresis characteristic of the model MDL is dynamically changed according to the situation. As a result, it is possible to realize more appropriate operability according to the situation. For example, by dynamically changing the hysteresis characteristic according to the operation speed or the speed V, it is possible to realize more natural operability.

### 2-3. Third Example

A maximum value of the operation input value IN input to the model unit 110 may be different for each operator. For example, since the limit of the force that can be exerted by the operator is various, the maximum value of the operation input F may be different for each operator. On the other hand, the range of the operation amount OPE of the target is preferably as uniform as possible regardless of the operator. For example, when the operators having different forces exert the maximum force of each of the operators, the operation amount OPE of the target is preferably as the same as possible. Otherwise, there is a possibility that a deviation occurs between the operation feeling and the response behavior of the target. The deviation between the operation feeling and the response behavior of the target brings a sense of discomfort to the operator.

Therefore, the third example proposes a technique capable of appropriately determining the operation amount OPE in consideration of the individuality of the operator.

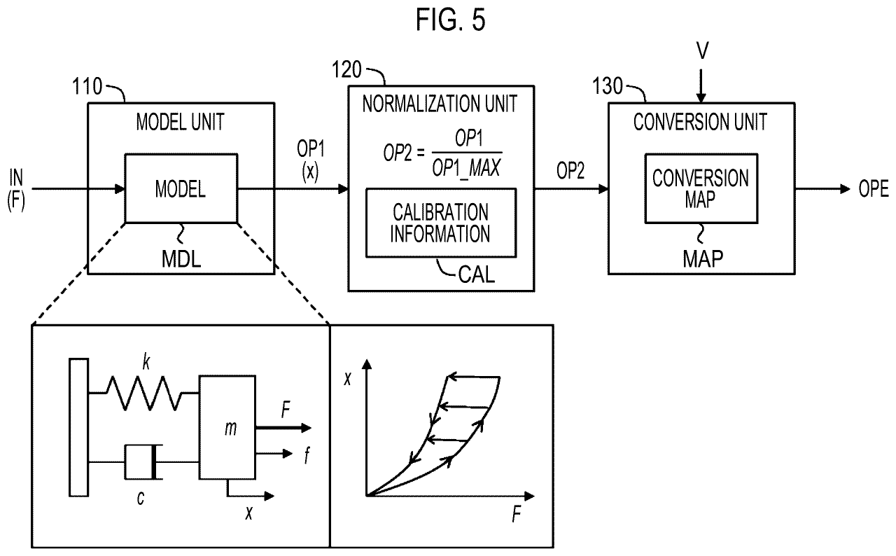

FIG. 5 is a conceptual diagram for describing a third example of the operation amount determination unit 100. The description overlapping the first example is appropriately omitted. The operation amount determination unit 100 includes a normalization unit 120 in addition to the model unit 110 and the conversion unit 130. The normalization unit 120 receives the operation output value OP1 output from the model unit 110. The normalization unit 120 acquires the normalized operation output value OP2 by normalizing the operation output value OP1.

Consider a certain operator (hereinafter, referred to as a “first operator”) who uses the operation system 1. The maximum operation input value IN_MAX is a maximum value (limit value) of the operation input value IN input by the first operator. The maximum operation output value OP1_MAX is the operation output value OP1 obtained when the maximum operation input value IN_MAX is input to the model MDL. That is, the maximum operation output value OP1_MAX is the operation output value OP1 corresponding to the maximum operation input value IN_MAX. In this case, the normalized operation output value OP2 is represented by a ratio of the operation output value OP1 to the maximum operation output value OP1_MAX. That is, the normalized operation output value OP2 is represented by the equation: OP2=OP1/OP1_MAX. The unit of the normalized operation output value OP2 is [%]. The normalization unit 120 acquires the normalized operation output value OP2 by normalizing the operation output value OP1 based on the maximum operation output value OP1_MAX.

The calibration may be performed before the first operator starts using the operation system 1. During the calibration, the first operator operates the operation member 10 with a desired maximum force. The normalization unit 120 acquires the operation output value OP1 obtained at that time as the maximum operation output value OP1_MAX. The calibration information CAL represents the maximum operation output value OP1_MAX obtained in this way. That is, the calibration information CAL represents the maximum operation output value OP1_MAX for the first operator. The normalization unit 120 holds the calibration information CAL. When the first operator uses the operation system 1, the normalization unit 120 can recognize the maximum operation output value OP1_MAX for the first operator based on the calibration information CAL and execute the normalization processing.

The conversion unit 130 receives the normalized operation output value OP2 output from the normalization unit 120. The conversion unit 130 converts the normalized operation output value OP2 into the operation amount OPE of the target. That is, the conversion unit 130 determines (calculates) the operation amount OPE of the target based on the normalized operation output value OP2. The conversion unit 130 may include a conversion map MAP for converting the normalized operation output value OP2 into the operation amount OPE. An example of the processing by the conversion unit 130 is as shown in FIG. 3.

As described above, according to the third example, the normalized operation output value OP2 can be obtained by normalizing the operation output value OP1. The operation amount OPE of the target is determined based on the normalized operation output value OP2. Therefore, even in a case where the maximum operation input value IN_MAX input to the model unit 110 is different for each operator, the range of the operation amount OPE of the target is uniform regardless of the operator. For example, when the operators having different forces exert the maximum force of each of the operators, the operation amount OPE of the target is the same. That is, even an operator having a weak force can operate the target with the same operation feeling as an operator having a strong force. Therefore, the deviation between the operation feeling and the response behavior of the target is suppressed. As a result, the sense of discomfort felt by the operator is suppressed.

### 2-4. Fourth Example

A combination of the second example and the third example is also possible. In this case, the effects of both the second example and the third example can be obtained.

### 3. Hardware Configuration Example

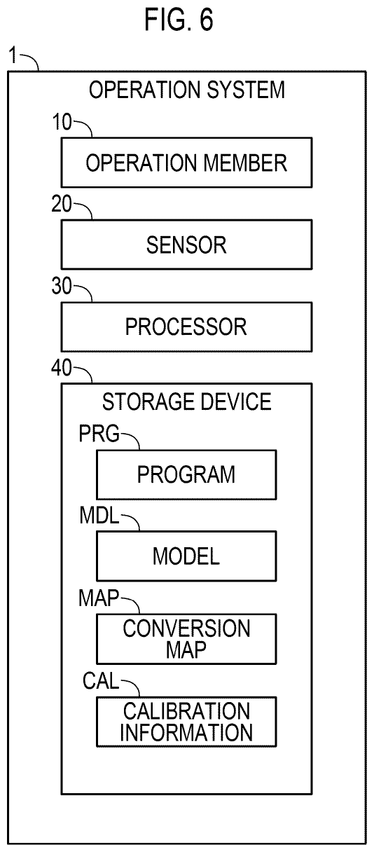

FIG. 6 is a block diagram showing a hardware configuration example of the operation system 1. The operation system 1 includes the operation member 10, the sensor 20, one or more processors 30 (hereinafter, simply referred to as a “processor 30”), and one or more storage devices 40 (hereinafter, simply referred to as a “storage device 40”).

The processor 30 executes various types of processing. Examples of the processor 30 include a general-purpose processor, an application-specific processor, a central processing unit (CPU), an application specific integrated circuit (ASIC), and a field-programmable gate array (FPGA). The processor 30 can also be referred to as processing circuitry. The storage device 40 stores various types of information needed for processing. Examples of the storage device 40 include a volatile memory, a non-volatile memory, a hard disk drive (HDD), and a solid state drive (SSD).

The storage device 40 stores the information on the model MDL, the conversion map MAP, and the calibration information CAL. The functions of the operation amount determination unit 100 and the controller 200 are realized by the cooperation between the processor 30 and the storage device 40.

The program PRG is a computer program executed by the processor 30. The program PRG is stored in the storage device 40. The program PRG may be recorded on a computer-readable recording medium. The functions of the operation amount determination unit 100 and the controller 200 may be realized by the cooperation between the processor 30 that executes the program PRG and the storage device 40.

What is claimed is:

1. An operation system that operates a target in response to an operation of an operation member by an operator, the operation system comprising:
one or more processors configured to receive an operation input value representing an operation content of the operation member by the operator; and
one or more storage devices configured to store information on a model configured to output an operation output value corresponding to the operation input value, wherein:
the model is configured such that a relationship between the operation input value and the operation output value has a hysteresis characteristic; and
the one or more processors are further configured to
input the operation input value to the model to acquire the operation output value, and
determine an operation amount of the target based on the operation output value.

2. The operation system according to claim 1, wherein:
the operation input value represents a force applied to the operation member;
the model is a spring-mass-damper model configured by a combination of a spring, a mass, and a damper; and
the operation output value is a displacement of the mass.

3. The operation system according to claim 1, wherein the hysteresis characteristic in the model is variable.

4. The operation system according to claim 3, wherein the one or more processors are further configured to
acquire information on an operation speed of the operation member based on the operation input value, and
dynamically change the hysteresis characteristic in the model in accordance with the operation speed of the operation member.

5. The operation system according to claim 1, wherein:
a maximum operation input value is a maximum value of the operation input value;
a maximum operation output value is the operation output value corresponding to the maximum operation input value; and
the one or more processors are further configured to
normalize the operation output value based on the maximum operation output value to acquire a normalized operation output value, and
determine the operation amount of the target based on the normalized operation output value.
